(19) United States
(12) Patent Application Publication
(10) Pub. No.: US 2013/0214092 A1
(43) Pub. Date: Aug. 22, 2013

(54) AERODYNAMIC BODY WITH AN ANCILLARY FLAP

(71) Applicant: Airbus Operations GmbH, (US)

(72) Inventor: Hendrik Friedel, Bremen (DE)

(73) Assignee: AIRBUS OPERATIONS GMBH, Hamburg (DE)

(21) Appl. No.: 13/749,974

(22) Filed: Jan. 25, 2013

Related U.S. Application Data
(63) Continuation of application No. PCT/EP2011/003740, filed on Jul. 26, 2011.
(60) Provisional application No. 61/367,650, filed on Jul. 26, 2010.

(30) Foreign Application Priority Data
Jul. 26, 2010 (DE) 10 2010 032 224.5

(51) Int. Cl. B64C 13/28

(52) U.S. Cl. CPC B64C 13/28
USPC 244/99.3

(57) ABSTRACT

An aerodynamic body with at least one ancillary flap on the aerodynamic body so it can be moved with a guide mechanism, and with a drive device for actuating the ancillary flap. The guide mechanism has a connecting lever, which at its first end is articulated on the aerodynamic body by a first pivotal articulation, and which at its second end is articulated on the ancillary flap by a second pivotal articulation. The second pivotal articulation is located at some distance from a trailing edge of the ancillary flap, and from a leading edge of the ancillary flap. The guide mechanism has an actuation element, which is coupled with the drive device. The actuation element is articulated on the ancillary flap by a third pivotal articulation. The third pivotal articulation is arranged such that it can be moved in the chordwise direction of the aerodynamic body.

### CROSS-REFERENCE TO RELATED APPLICATIONS

This application is a continuation of and claims priority to PCT Application No. PCT/EP2011/003740, filed Jul. 26, 2011, which claims the benefit of the filing date of German Patent Application No. DE 10 2010 032 224.5 filed Jul. 26, 2010 and of U.S. Provisional Patent Application No. 61/367,650 filed Jul. 26, 2010, the disclosures of which applications are hereby incorporated herein by reference.

### TECHNICAL FIELD

The invention concerns an aerodynamic body with at least one ancillary flap.

### BACKGROUND

From DE 41 07 556 C1 a drive-and-guide device for a flap arranged on an aeroplane wing, in particular for a trailing edge or landing flap, is of known art. The drive-and-guide device comprises a trolley, on which the flap is held such that it can be moved, and which can be traversed on a support and guide rail.

EP 1 312 545 B1 describes an aerodynamic lifting body with an adjustable flap, which has a forward lifting body region, and also a rearward lifting body region located in the wake flow, and which is bounded by a covering skin on both the pressure surface and the suction surface. The pressure surface and suction surface covering skins converge in the rearward lifting body region into a lifting body trailing edge.

### SUMMARY

The object of the invention is to create an aerodynamic lifting body with an ancillary flap, in which a drive device for purposes of actuating the ancillary flap, has a small space requirement, which is aerodynamically particularly favourable and/or with which the ancillary flap is aerodynamically arranged in a particularly effective manner.

This object is achieved with the features of Claim 1. Further forms of embodiment are specified in the dependent claims that refer back to the latter.

The invention concerns an aerodynamic body, which in particular can be a lifting body, with at least one ancillary flap arranged on the aerodynamic body such that it can be moved with the aid of a guide mechanism, and with a drive device for purposes of actuating the ancillary flap. The guide mechanism comprises a connecting lever, which at its first end is articulated on the aerodynamic body by means of a first pivotal articulation, and which at its second end is articulated on the ancillary flap by means of a second pivotal articulation. The second pivotal articulation is located at some distance from a trailing edge of the ancillary flap, and at some distance from a leading edge of the ancillary flap. Furthermore the guide mechanism has an actuation element, which is coupled with the drive device.

In accordance with the invention provision is made that the actuation element is articulated on the ancillary flap by means of a third pivotal articulation, and that the third pivotal articulation is arranged such that it can be moved along or in the chordwise direction of the aerodynamic body.

In particular, according to an embodiment of the invention, the third pivotal articulation is guided such at the aerodynamic body that it can be moved in a translational direction along the aerodynamic body.

The ancillary flap which can be swung out serves the purpose of altering the lift coefficient of the aerodynamic body particularly under certain flight conditions. The third pivotal articulation that can be moved along the chordwise direction of the aerodynamic body contributes to this purpose in that the drive device for purposes of moving the ancillary flap is configured in a particularly simple and space-saving manner. Moreover the drive device can be arranged completely within a covering skin of the main wing, as a result of which in cruise flight a particularly low air resistance ensues, which is particularly favourable aerodynamically.

The aerodynamic body can be a main wing of a wing, which in addition to the main wing and the ancillary flap can also comprise leading edge slats or further flaps. Alternatively the aerodynamic lifting body is, for example, a leading-edge slat of the wing, or one of the flaps of the wing, which are arranged on the main wing such that they can be moved. The flap on which the ancillary flap is articulated, can be, for example, a control flap, and in particular a spoiler, or a high lift flap, and in particular a trailing edge flap. In this context the ancillary flap can also be embodied as a mini trailing edge flap. Here the mini trailing edge flap can be embodied such that its chord amounts to 0.3 to 7% of the chord of the main wing, if the mini trailing edge flap is arranged on the main wing, or such that its chord amounts to 0.3 to 7% of the chord of the flap, if the mini trailing edge flap is arranged on a flap.

In accordance with one example of embodiment the ancillary flap is arranged on the pressure surface or lower surface of the aerodynamic body provided in accordance with its intended purpose, and can be extended in the direction of the pressure surface or downwards. In other words, when deployed in accordance with its intended purpose the ancillary flap is arranged on the lower surface of the aerodynamic body, and can be extended downwards. Alternatively the ancillary flap, is arranged on the suction surface of the aerodynamic body and can be extended in the direction of the suction surface.

In accordance with a further example of embodiment the third pivotal articulation is arranged in the forward region of the ancillary flap. The forward region is the region of the ancillary flap associated with or located near the aerodynamic leading edge of the main wing or flap, on which the ancillary flap is arranged in each case. In the form of embodiment with the arrangement of the ancillary flap on a flap, as the ancillary flap is extended a trailing edge of the ancillary flap is displaced further rearwards in the chordwise direction with an increasing extension path, as a result of which the effectiveness of the ancillary flap increases. Alternatively the third pivotal articulation is arranged in the rearward region of the ancillary flap.

In a further example of embodiment the third pivotal articulation is arranged on a slide, which is guided in the chordwise direction such that it can be moved in a guide device, which depending on whether the ancillary flap is arranged on the main wing or on the flap, is arranged on the main wing, or on the flap. This represents a particularly simple and effective option for moving the third pivotal articulation in the chordwise direction.

In accordance with a further example of embodiment the actuation element and the third pivotal articulation are arranged in all positions of the ancillary flap within the covering, that is to say, within the outer skin of the main wing. This enables the air resistance not to be increased in any setting of the ancillary flap as a result of the actuation element, or the third pivotal articulation.

A reliable actuation of the ancillary flap can, for example, be ensured if the connecting lever, at least when the ancillary flap is fully retracted, subtends an angle of at least 5° with a connecting straight line that passes through the second and third pivotal articulations. The angle can also be denoted as a transmission angle. With angles of less than 5° the guide mechanism approaches its dead-centre position. The closer the guide mechanism is to its dead-centre position, the more force is necessary to actuate it, and a delay in the actuation can in fact occur. As a result of the possibility of a large force the components must be configured in a particularly robust manner. Operating the guide mechanism outside the dead-centre position thus enables simple and light components to be used, in particular a drive device with a lower power rating, which can than likewise be configured in a simpler and lighter manner.

In one example of embodiment the first pivotal articulation, at least in the retracted setting of the ancillary flap, is arranged, as viewed from the leading edge of the aerodynamic body, behind the second pivotal articulation in the chordwise direction. With the movement of the third pivotal articulation rearwards in the chordwise direction this causes the ancillary flap to extend, and with an opposite movement, to retract once again. Furthermore this contributes to the reliable actuation of the ancillary flap. In an alternative example of embodiment the first pivotal articulation, at least in the retracted setting of the ancillary flap, is arranged ahead of the second pivotal articulation, as viewed in the chordwise direction. With the movement of the third pivotal articulation in the chordwise direction/this causes the ancillary flap to extend, and with an opposite movement, to retract once again.

### BRIEF DESCRIPTION OF THE DRAWINGS

In what follows examples of embodiment of the invention are described with the aid of the accompanying figures. In the figures:

FIG. 1 shows a cross-section through a rearward region of a first example of embodiment of the aerodynamic body in accordance with the invention with a retracted additional flap,

FIG. 2 shows a cross-section through a rearward region of the first example of embodiment of the aerodynamic body in accordance with the invention with a partially extended ancillary flap,

FIG. 3 shows a cross-section through a rearward region of the first example of embodiment of the aerodynamic body with a fully extended ancillary flap,

FIG. 4 shows a cross-section through the rearward region of a second example of embodiment of the aerodynamic body with a retracted additional flap,

FIG. 5 shows a cross-section through the rearward region of the second example of embodiment of the aerodynamic body with a partially extended ancillary flap,

FIG. 6 shows a cross-section through the rearward region of a third example of embodiment of the aerodynamic body with a partially extended ancillary flap,

FIG. 7 shows a cross-section through the rearward region of a fourth example of embodiment of the aerodynamic body with a retracted additional flap,

FIG. 8 shows a cross-section through the rearward region of the fourth example of embodiment of the aerodynamic body with a partially extended ancillary flap.

### DETAILED DESCRIPTION

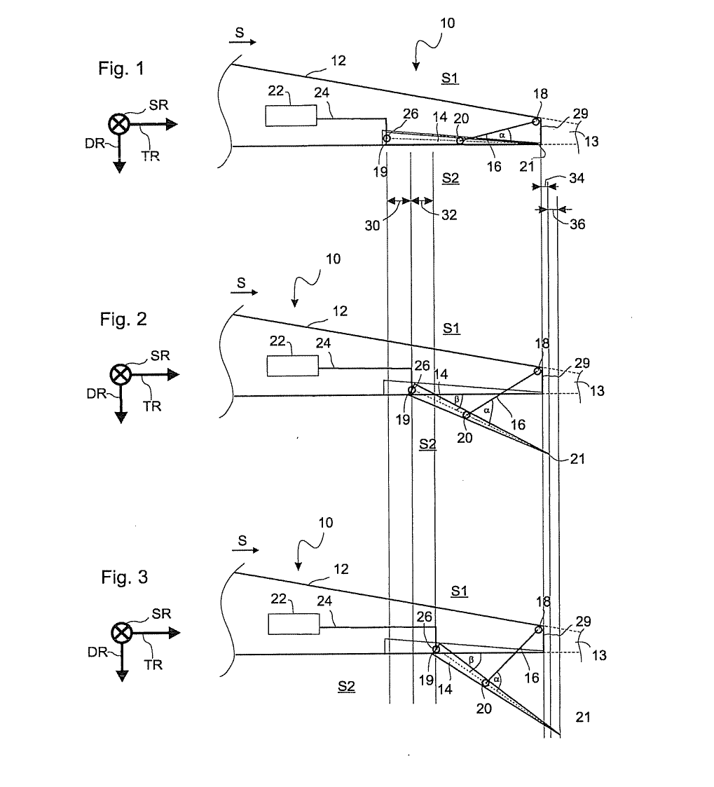

Elements of the same design or function are allocated the same reference symbols across the figures. For purposes of describing the aerodynamic body in accordance with the invention reference is made to the coordinate system KS registered e.g. in FIG. 1, with a spanwise direction SW, a chordwise direction TR, and a wing thickness direction DR of the aerodynamic body respectively.

FIG. 1 shows a cross-section through a rearward region, as viewed in the chordwise direction TR, of an aerodynamic body in the form of a main wing 12 or an adjustable flap or a high lift flap. In particular, the aerodynamic body can be a leading edge slat of the wing 10, or a flap of the wing 10, which is arranged on the main wing 12 of the wing 10 and which can be moved between a neutral and at least one extended position, for example, a trailing edge flap, or a control flap such as a spoiler. An optionally provided trailing edge 13 of the main wing 10 is just partially represented and indicated as a dashed line. The upper surface of the aerodynamic body or main wing 12 associated with a suction surface S1 facing a suction area generated by the flow around the aerodynamic body, and the lower surface associated with a pressure surface S2, can converge at an acute angle at the trailing edge 13 of the aerodynamic body with the suction surface 51. The suction surface S1 and the pressure surface S2 ensue from the flow around the aerodynamic body 10 as a result of a flow incident onto the latter with a flow direction S in accordance with its intended purpose.

Generally, the main wing or the adjustable flap has a first or upper side and a first or upper aerodynamic surface and has a second or lower side and second or lower aerodynamic surface, which is lying or is directed in opposite to the first aerodynamic surface. The ancillary flap 14 is coupled to the main wing or the flap, respectively, such that it is located at a second or lower side of the wing or the flap. Preferably, the second or lower side of the ancillary flap 14 is completing the second surface of the main wing or the flap, respectively, when the ancillary flap 14 is in its retracted position so that, in this state, the second or lower side of the ancillary flap 14 is aerodynamically a part of the second surface of the main wing or the flap.

With the aid of a guide mechanism 25 an ancillary flap 14 is arranged such that it can be moved on the main wing 12; the aerodynamically effective surface area of the wing 10 can be modified as a function of its setting. The length of the ancillary flap 14 corresponds, for example, to between 0.2 and 50 percent of the length of the aerodynamic body in the chordwise direction TR. In particular, the ancillary flap 14 can be realized as mini flap with a maximum chord length or a mean chord length between 0.2 percent and 5 percent of the mean chord length of the main wing or the flap, respectively, in the spanwise area of the ancillary flap 14. Alternatively, the ancillary flap 14 can be realized as control flap or adjustable flap, being coupled to a main wing or another flap and in particular a high lift flap. In FIG. 1 the ancillary flap 14 is located in the retracted state. In particular, the ancillyra flap 14 is located in all its positions relative to the of the main wing or the flap, respectively, at the lower surface of the of the main wing or the flap, respectively. Fundamentally, the ancillary flap 14 has a non-negligible thickness. For example, a lower surface of the ancillary flap 14 associated withf the pressure surface S2 in the cruise setting, that is to say with the ancillary flap retracted, can be aligned with the lower surface of the main wing 12. By this means the air resistance of a retracted ancillary flap 14 is reduced. This leads to a reduction of the noise emission and fuel consumption, which leads to an increase in the range of the aeroplane. Furthermore one covering surface of the main wing or the flap, respectively, can be dispensed with, since the ancillary flap 14 itself serves as a covering surface of the main wing or the flap, respectively, as a result of which weight can be saved, which in turn leads to a reduction of fuel consumption.

The guide mechanism 25 has a connecting lever 16, a first pivotal articulation 18, a second pivotal articulation 20, a third pivotal articulation 26, and an actuation element 24. The guide mechanism 25 serves the purpose of supporting the ancillary flap 14 such that it can be moved on the aerodynamic body and guiding it in its extension movement. The connecting lever 16 on the one hand is articulated on the main wing 12 by means of a first pivotal articulation 18, and on the other hand is articulated on the ancillary flap 14 by means of a second pivotal articulation 20. The length of the connecting lever 16 can in particular amount to between 0.25 and 2.5 percent of the wing chord of the aerodynamic body. The first pivotal articulation 18 is arranged in a spar 29 of the main wing 12. The first pivotal articulation 18 is, for example, as viewed in the chordwise direction TR, arranged in a rearward region of the aerodynamic body, which is located at some distance from the trailing edge of the aerodynamic body, which in accordance with one form of embodiment in accordance with the invention corresponds to not more than 0.25 percent of the wing chord of the aerodynamic body. The second pivotal articulation 20 is arranged stationary with regard to its chrodwise position on the ancillary flap 14, and is located at some distance both from a leading edge 19 of the ancillary flap 14 and also from a trailing edge 21 of the ancillary flap 14. In particular, according to an embodiment of the invention, the second pivotal articulation 20 is located in the chordwise middle area extending 80% of the total maximum chord length of the ancillary flap and preferably in the chordwise middle area extending 50% of the total maximum chord length of the ancillary flap.

In the forward region of the ancillary flap 14, in particular at the leading edge 19, the ancillary flap 14 is articulated on the main wing 12 by means of the third pivotal articulation 26. When the ancillary flap 14 is retracted the forward region of the ancillary flap 14 is located, as viewed in the flow direction, at the front of the ancillary flap 14, i.e. the end which is lying opposite to the leading edge of the ancillary flap or the main wing and the adjustable flap, respectively. The third pivotal articulation 26 is coupled by means of the actuation element 24 or actuation rod, for example a stroke rod, with a drive device 22. The actuation element can also be a lever of a drive device 22 in form of a rotary drive. The third pivotal articulation 26 is arranged such that it can be moved in the chordwise direction TR along the aerodynamic body 10 or the main wing and the adjustable flap, respectively, and can be displaced with the aid of the drive device 22 and the actuation element 24 in the chordwise direction TR. The rearwards displacement of the third pivotal articulation 26, as viewed in the chordwise direction TR, or in direction to the leading edge of the aerodynamic body 10, together with the effect of the connecting lever 16, causes the extension of the ancillary flap 14 and guides the same. Alternatively the third pivotal articulation 19 can also be moved in the chordwise direction TR with the aid of an eccentric or a lever which, respectively, are coupled to the aerodynamic body at a first station or point, and to which the leading edge of the ancillary flap 14 is coupled at a second station or point lying in a concrete distance from the first station or point. The drive device 22 can in particular be constituted from an actuator operating electrically or hydraulically, for example a linear actuator, which acts directly onto the actuation element 24, or a rotary actuator, which acts by means of a spindle onto the actuation element 24. In particular, the articulation 26 can be guided along the aerodynamic body by a guiding track being fixed or hingedly coupled to the aerodynamic body 10. Alternatively, the drive device 22 can be constituted in terms of a passive coupling, by means of which on the basis of a specified mechanism the movement of the ancillary flap 14 is linked with a movement of the aerodynamic body, for example the leading edge slat or the flap. A movement of the aerodynamic body then causes a retraction or extension movement of the ancillary flap 14.

The connecting lever 16 and an imaginary straight line through the second and third pivotal articulations 20, 19, which on the basis of the dashed line representation in the figures is represented by the ancillary flap 14, preferably subtend in all settings of the ancillary flap 14, in particular in the retracted setting, an angle, in particular a transmission angle α between the extension direction of the lever 16 and the chord or middle fiber (the center of area line of the profile cross-section), of at least 5°. By this means the guide mechanism 25 is permanently located outside its dead-centre position. This contributes to the purpose that only a small force is necessary in order to move the ancillary flap 14. By this means the actuator of the drive device 22 can be selected to be relatively small, as a result of which a particularly rapid adjustment is possible. Furthermore, both the actuator and also the guide mechanism 25 can be configured to be relatively light and simple, which also contributes to an ability to make rapid adjustments.

FIG. 2 shows the ancillary flap 14 in a partially extended setting. In the partially extended setting the third pivotal articulation 19 is displaced relative to the retracted setting by a first distance 30 along the chordwise direction TR towards the trailing edge 13 of the aerodynamic body 10 or main wing 12 at the aerodynamic body 10. This causes firstly a load between the connecting lever 16 and the ancillary flap 14. In response to this load the second pivotal articulation 20 moves in the direction of the pressure surface S2, and both the connecting lever 16 and also the ancillary flap 14 extend downwards. In particular the ancillary flap 14 rotates about an axis defined by the third pivotal articulation 26. In addition the whole ancillary flap 14 is displaced rearwards in the chordwise direction TR, in particular the trailing edge 21 of the ancillary flap 14 is displaced rearwards by a second distance 34 in the chordwise direction TR, as a result of which the aerodynamic effectiveness of the ancillary flap 14 is increased. In particular the lift and the maximum lift with an extended ancillary flap 14 thereby improve. The fact that the third pivotal articulation 19 is displaced along the chordwise direction TR signifies in this context and in what follows that the third pivotal articulation 19 is displaced in a direction that is displaced parallel to at least one direction component of the chordwise direction TR.

FIG. 3 shows the ancillary flap 14 in a fully extended setting. In particular the ancillary flap 14, and the lower surface of the main wing 12, subtend an extension angle β of 60 degrees. Alternatively the ancillary flap 14, and the lower surface of the main wing 12 in the fully extended setting of the ancillary flap 14 can subtend an extension angle β of approx. 90 degrees. In the fully extended setting the third pivotal articulation 19 compared with the partially extended setting is displaced by a further, in particular a third, distance 32 in the direction of the trailing edge 13 of the main wing 12. This causes a progressive movement of the second pivotal articulation 20 directed downwards in the direction of the pressure surface S2, and both the connecting lever 16 and also the ancillary flap 14 extend further downwards. In addition the trailing edge 21 of the ancillary flap 14 is displaced further rearwards by a fourth distance 36 in the chordwise direction TR, as a result of which the aerodynamic effectiveness of the ancillary flap 14 is further increased.

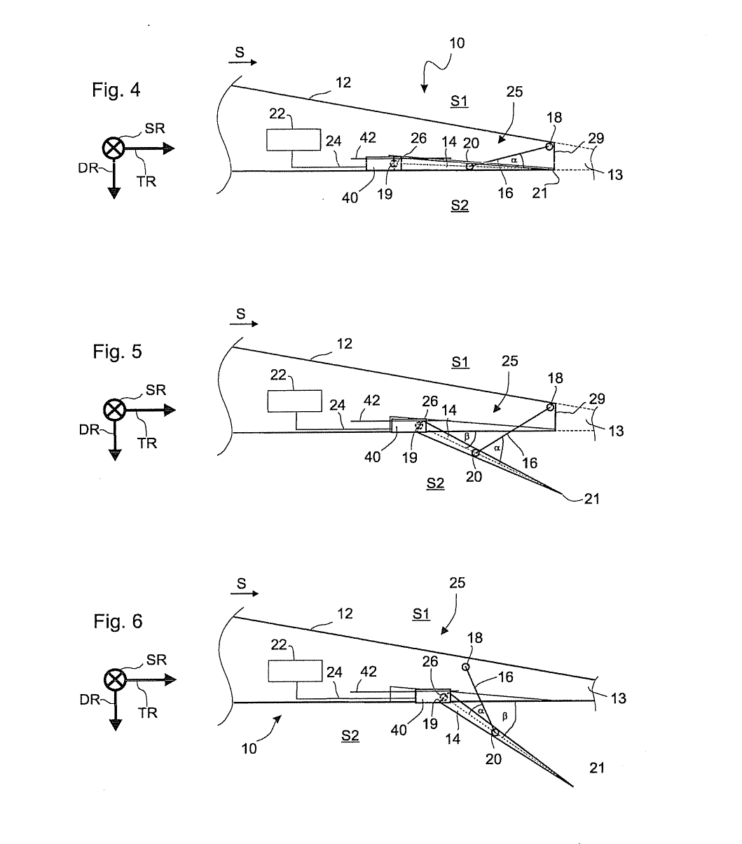

FIG. 4 shows a cross-section through a rearward region, as viewed in the chordwise direction TR of the aerodynamic body 10, of an alternative example of embodiment of the wing 10 with the aerodynamic body, in particular the main wing 12. The wing 10 has the main wing 12 and the ancillary flap 14; the aerodynamically effective surface area of the wing 10 can be modified as a function of the setting of the ancillary flap 14. The trailing edge 13 of the main wing 12 in this example of embodiment also is just partially represented and indicated as a dashed line. The upper surface and the lower surface of the main wing 10 can converge at an acute angle at the trailing edge 13.

In FIG. 4 the ancillary flap 14 is located in the retracted state and in the interests of clarity is represented once again in the form of a dashed line. Fundamentally, however, this ancillary flap 14 also has a non-negligible thickness. For example, a lower surface of the ancillary flap 14 associated with the pressure surface S2 in the cruise setting, that is to say in the retracted state, can be aligned with the lower surface of the main wing 12. This is particularly favourable aerodynamically during cruise flight and enables one covering surface to be dispensed with.

The ancillary flap 14 is coupled with the main wing 12 by means of the connecting lever 16. The connecting lever 16 on the one hand is articulated on the main wing 12 by means of the first pivotal articulation 18, and on the other hand is articulated on the ancillary flap 14 by means of the second pivotal articulation 20. The first pivotal articulation 18 is articulated on the main wing 12 by means of a spar 29. The second pivotal articulation 20 is connected securely with the ancillary flap 14 and is located at some distance both from the leading edge 19 of the ancillary flap 14 and also from the trailing edge 21 of the ancillary flap 14.

In the forward region of the ancillary flap 14, in particular at the leading edge 19, the ancillary flap 14 is articulated on the main wing 12 by means of the third pivotal articulation 26. The third pivotal articulation 26 is mounted on a slide 40. With the aid of a guide device, in particular a guide rail 42, the slide 40 is guided along the chordwise direction TR and can be moved along the guide rail 42 in the chordwise direction TR. The slide 40 is coupled with the drive device 22 by means of the actuation element 24, and can be displaced with the aid of the drive device 22 and the actuation element 24 along the chordwise direction TR. The displacement of the slide 40 along the chordwise direction TR causes the displacement of the third pivotal articulation 26 rearwards along the chordwise direction TR, which leads to the extension of the ancillary flap 14.

The connecting lever 16 and the imaginary straight line through the second and third pivotal articulations 20, 26, in this example of embodiment also preferably subtend in all settings of the ancillary flap 14, in particular in the retracted setting, an angle of at least 5°. By this means the guide mechanism 25 is permanently located outside its dead-centre position.

FIG. 5 shows the ancillary flap 14 of the second example of embodiment in a partially extended setting. In the partially extended setting the slide 40 is displaced rearwards relative to the retracted setting in the direction of the trailing edge 13 of the main wing 12. This causes firstly a load between the connecting lever 16 and the ancillary flap 14. In response to this load the second pivotal articulation 20 moves in the direction of the pressure surface S2, and both the connecting lever 16 and also the ancillary flap 14 extend downwards. In addition the trailing edge 21 of the ancillary flap 14 is displaced rearwards in the chordwise direction TR, as a result of which the aerodynamic effectiveness of the ancillary flap 14 is increased.

FIG. 6 shows a third example of embodiment of the aerodynamic body. The ancillary flap 14 is coupled with the main wing 12 by means of the connecting lever 16. The connecting lever 16 on the one hand is articulated on the main wing 12 by means of the first pivotal articulation 18, and on the other hand is articulated on the ancillary flap 14 by means of the second pivotal articulation 20. The second pivotal articulation 20 is connected securely with the ancillary flap 14 and is located at some distance both from the leading edge 19 of the ancillary flap 14 and also from the trailing edge 21 of the ancillary flap 14. In the region of the leading edge 19 the ancillary flap 14 is articulated on the main wing 12 by means of the third pivotal articulation 26. The third pivotal articulation 26 is coupled by means of the slide 40 and the actuation element 24 with the drive device 22. The third pivotal articulation 18, at least with the ancillary flap 14 retracted, and with the variant shown even in a partially extended setting of the ancillary flap 14, as viewed in the chordwise direction TR, is arranged ahead of the second pivotal articulation 20. In this example of embodiment, therefore, in contrast to the above elucidated examples of embodiment, the ancillary flap 14 extends with a forwards movement of the slide 40, in particular of the third pivotal articulation 26, in the chordwise direction TR, and with a rearwards movement of the slide 40 retracts once again.

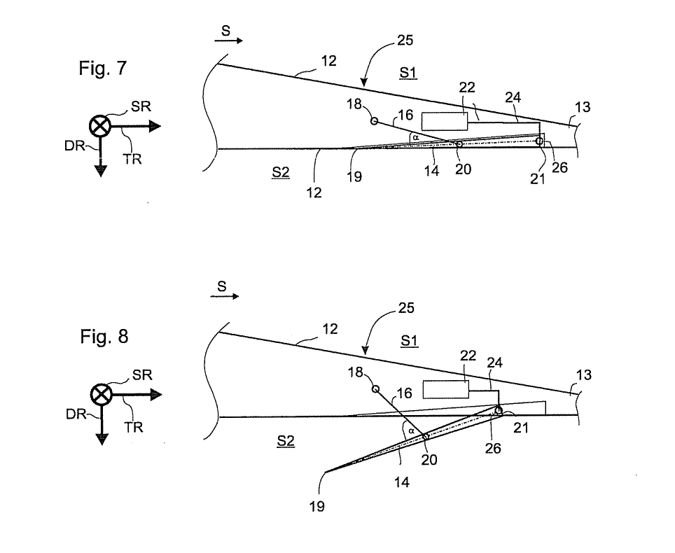

FIG. 7 shows a fourth example of embodiment of the aerodynamic body with the ancillary flap 14. The ancillary flap 14 is articulated on the main wing 12 by means of the third pivotal articulation 26 and is articulated on the connecting lever 16 by means of the second pivotal articulation 20; the connecting lever 16 is articulated on the main wing by means of the first pivotal articulation 18. With the ancillary flap 14 retracted firstly the first pivotal articulation 18, then the second pivotal articulation 20, and then the third pivotal articulation 26, are arranged in the flow direction, as viewed from the front. The third pivotal articulation 26 is once again arranged such that it can be moved in the chordwise direction TR, and for this purpose is connected with the actuation element 24 coupled with the drive device 22.

FIG. 8 shows the fourth example of embodiment as per FIG. 7, wherein the ancillary flap 14 is partially extended and wherein the third pivotal articulation 26 is correspondingly displaced forwards relative to the flow direction. In the first through to the third examples of embodiment the ancillary flap 14 extends out of its retracted state such that an opening of the extension angle β is directed, at least initially, in the flow direction. In contrast in the fourth example of embodiment the ancillary flap 14 extends out of its retracted state such that the opening of the extension angle 13 is directed at least initially against the flow direction, and such that an inner surface of the ancillary flap 14, which in the retracted state is facing the main wing 12, in the extended state is subjected to a stagnation pressure as a result of the airflow.

The pivotal articulations 18, 20, 26 are preferably axial articulations. Alternatively one, two, or all three pivotal articulations 18, 20, 26 can be designed as ball races. The pivotal articulations 18, 20, 26 and also the actuation element 24 and the drive device 22 in all settings of the ancillary flap 14 are located within the main wing 12. By this means compared with conventional drive systems for ancillary flaps 14 covering surfaces for the components can be dispensed with, as a result of which the weight is reduced.

The invention is not limited to the examples of embodiment specified. The various examples of embodiment can, for example, be combined with one another. For example, in all examples of embodiment with the ancillary flap retracted the first pivotal articulation can be arranged ahead of the second pivotal articulation in the chordwise direction. Furthermore the drive device of the first example of embodiment can also be used in the other examples of embodiment.

### REFERENCE SYMBOL LIST

10 Wing
12 Main wing
13 Main wing trailing edge
14 Ancillary flap
16 Connecting lever
18 First pivotal articulation
19 Ancillary flap leading edge
20 Second pivotal articulation
21 Ancillary flap trailing edge
22 Drive device
24 Actuation element
25 Guide mechanism
26 Third pivotal articulation
29 Spar
30 First distance
32 Third distance
34 Second distance
36 Fourth distance
40 Slide
42 Guide rail
S1 Suction surface
S2 Pressure surface
TR Chordwise direction
SW Spanwise direction
DR Thickness direction
α Transmission angle
β Extension angle

1. An aerodynamic body with at least one ancillary flap on the aerodynamic body such that it can be moved with the aid of a guide mechanism, and with a drive device for purposes of actuating the ancillary flap, the guide mechanism comprising:
a connecting lever, which at its first end is articulated on the aerodynamic body by a first pivotal articulation, and which at its second end is articulated on the ancillary flap by a second pivotal articulation, wherein the second pivotal articulation is located at some distance from a trailing edge of the ancillary flap and from a leading edge of the ancillary flap,
an actuation element, which is coupled with the drive device,
characterised in that the actuation element is articulated on the ancillary flap by a third pivotal articulation, and in that the third pivotal articulation is arranged such that it can be moved along the aerodynamic body in the chordwise direction of the aerodynamic body.

2. The aerodynamic body in accordance with claim 1, characterised in that the aerodynamic lifting body is designed as a main wing of a wing.

3. The aerodynamic body in accordance with claim 1, characterised in that the aerodynamic lifting body is designed as a flap, which is arranged on a main wing of a wing such that it can be extended.

4. The aerodynamic body in accordance with claim 1, characterised in that the ancillary flap is arranged on the pressure surface of the aerodynamic body, and is arranged such that it can be extended in the direction of the pressure surface.

5. The aerodynamic body in accordance with claim 1, characterised in that the ancillary flap is arranged on a suction surface of the aerodynamic body, and is arranged such that it can be extended in the direction of the suction surface.

6. The aerodynamic body in accordance with claim 1, characterised in that the third pivotal articulation is articulated on the ancillary flap in the forward region of the ancillary flap, wherein the forward region with the ancillary flap retracted, is designed at the front of the ancillary flap, as viewed in the flow direction.

7. The aerodynamic body in accordance with claim 1, characterised in that the third pivotal articulation, for purposes of coupling the actuation element with the ancillary flap, is arranged in the rearward region of the ancillary flap with reference to the chordwise direction.

8. The aerodynamic body in accordance with claim 1, characterised in that the third pivotal articulation is arranged on a slide, which is guided along a chordwise direction such that it can be moved in a guide device.

9. The aerodynamic body in accordance with claim 1, characterised in that the actuation element and the third pivotal articulation are arranged in all positions of the ancillary flap within a covering skin of the main wing.

10. The aerodynamic body in accordance with claim 1, characterised in that the connecting lever with a fully retracted ancillary flap subtends an angle of at least 5° with a connecting straight line, which passes through the second and third pivotal articulations.

11. The aerodynamic body in accordance with claim 1, characterised in that the first pivotal articulation, at least in the retracted setting of the ancillary flap, is arranged, as viewed from the aerodynamic leading edge of the main wing, behind the second pivotal articulation in the chordwise direction.

12. The aerodynamic body in accordance with claim 1, characterised in that the first pivotal articulation, at least in the retracted setting of the ancillary flap, is arranged, as viewed in the chordwise direction, ahead of the second pivotal articulation.
